(19) United States
(12) Patent Application Publication
(10) Pub. No.: US 2023/0378610 A1
(43) Pub. Date: Nov. 23, 2023

(54) POLYMER BLOCKER FOR SOLID-STATE BATTERY

(71) Applicant: GM GLOBAL TECHNOLOGY OPERATIONS LLC, Detroit, MI (US)

(72) Inventors: Zhe LI, Shanghai (CN); Meiyuan WU, Shanghai (CN); Yong LU, Shanghai (CN); Haijing LIU, Shanghai (CN)

(73) Assignee: GM GLOBAL TECHNOLOGY OPERATIONS LLC, Detroit, MI (US)

(21) Appl. No.: 17/869,657

(22) Filed: Jul. 20, 2022

(30) Foreign Application Priority Data
May 23, 2022 (CN) CN202210563207.4

(51) Int. Cl. H01M 50/46; H01M 4/04; H01M 10/0525; H01M 50/409; H01M 10/0565

(52) U.S. Cl. CPC H01M 50/46; H01M 4/0404; H01M 10/0525; H01M 50/409; H01M 10/0565; H01M 2300/0082

(57) ABSTRACT

A polymer blocker for use in an electrochemical battery that cycles lithium ions is provided. The polymer blocker includes a polymeric layer, a first adhesive layer that includes a first adhesive and is disposed on or near a first surface of the polymeric layer, and a second adhesive layer that includes a second adhesive and is disposed on or near a second surface of the polymeric layer. The polymeric layer has a porosity greater than or equal to about 50 vol. % to less than or equal to about 95 vol. %. A portion of the first adhesive impregnates a first portion of the polymeric layer, and a portion of the second adhesive impregnating a second portion of the polymeric layer. The first and second portions of the polymeric layer may be the same or different.

### CROSS-REFERENCE TO RELATED APPLICATIONS

This application claims the benefit and priority of Chinese Application No. 202210563207.4 filed May 23, 2022. The entire disclosure of the above application is incorporated herein by reference.

### INTRODUCTION

This section provides background information related to the present disclosure which is not necessarily prior art.

Electrochemical energy storage devices, such as lithium-ion batteries, can be used in a variety of products, including automotive products such as start-stop systems (e.g., 12V start-stop systems), battery-assisted systems (“OAS”), Hybrid Electric Vehicles (“HEVs”), and Electric Vehicles (“EVs”). Typical lithium-ion batteries include two electrodes and an electrolyte component and/or separator. One of the two electrodes can serve as a positive electrode or cathode, and the other electrode can serve as a negative electrode or anode. Lithium-ion batteries may also include various terminal and packaging materials. Rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery. A separator and/or electrolyte may be disposed between the negative and positive electrodes. The electrolyte is suitable for conducting lithium ions between the electrodes and, like the two electrodes, may be in a solid form, a liquid form, or a solid-liquid hybrid form. In the instances of solid-state batteries, which includes a solid-state electrolyte layer disposed between solid-state electrodes, the solid-state electrolyte physically separates the solid-state electrodes so that a distinct separator is not required.

Solid-state batteries have advantages over batteries that include a separator and a liquid electrolyte. These advantages can include a longer shelf life with lower self-discharge, simpler thermal management, a reduced need for packaging, and the ability to operate within a wider temperature window. For example, solid-state electrolytes are generally non-volatile and non-flammable, so as to allow cells to be cycled under harsher conditions without experiencing diminished potential or thermal runaway, which can potentially occur with the use of liquid electrolytes. In addition, solid-state electrolytes can readily enable bipolar battery configurations with an easy build-up of output voltage. However, bipolar solid-state batteries often experience comparatively low power capabilities. Low power capabilities may be a result of interfacial resistance within the solid-state electrodes caused by limited contact, or void spaces, between the solid-state active particles and/or the solid-state electrolyte particles. Introducing soft mediums (e.g., gel polymer electrolytes) into bipolar solid-state batteries can help improve interfaces, and therefore, battery performance. However, the introduction of soft mediums often increases the risk of leakage, especially during high-temperature operations, which can result in ionic short-circuit of bipolar solid-state batteries. Accordingly, it would be desirable to develop high-performance bipolar solid-state battery designs, materials, and methods that eliminates or mitigates possible leakage.

### SUMMARY

This section provides a general summary of the disclosure, and is not a comprehensive disclosure of its full scope or all of its features.

The present disclosure relates to solid-state batteries and methods of forming and using the same. More particularly, the present disclosure relates to polymer blockers for use in solid-state batteries, and methods of forming and using the same.

In various aspects, the present disclosure provides a polymer blocker for use in an electrochemical battery that cycles lithium ions. The polymer blocker may include a polymeric layer, a first adhesive layer that includes a first adhesive and is disposed on or near a first surface of the polymeric layer, and a second adhesive layer that includes a second adhesive and is disposed on or near a second surface of the polymeric layer. The polymeric layer may have a porosity greater than or equal to about 50 vol. % to less than or equal to about 95 vol. %. A portion of the first adhesive may impregnates a first portion of the polymeric layer. A portion of the second adhesive may impregnate a second portion of the polymeric layer. The first and second portions of the polymeric layer may be the same or different. The second surface of the polymeric layer may be parallel with the first surface of the polymeric layer.

In one aspect, the first and second adhesives may together fill greater than or equal to about 80% to less than or equal to about 100% of a total porosity of the polymeric layer.

In one aspect, the polymer blocker may have an average thickness greater than or equal to about 2 μm to less than or equal to about 400 μm.

In one aspect, the polymeric layer may have an average thickness greater than or equal to about 2 μm to less than or equal to about 100 μm.

In one aspect, the polymeric layer may include a material selected from the group consisting of: polyester nonwoven separator, cellulose separator, polyvinylidene fluoride (PVDF) membrane, polyimide membrane, polyolefin-based separator, ceramic-coating separator, high-temperature stable separator, oxide particle layers, and combinations thereof.

In one aspect, at least one of the first and second adhesives includes a hot-melt adhesive.

In one aspect, at least one of the first and second adhesives includes an amorphous polypropylene resin prepared by copolymerizing at least two of ethylene, propylene, and butene.

In one aspect, the first and second adhesives may be independently selected from the group consisting of: polyethylene resin, polypropylene resin, polybutylene resin, urethane resin, polyamide resin, ethylene, propylene, butene, silicon, polyimide resin, epoxy resin, acrylic resin, ethylene-propylenediene rubber (EPDM), isocyanate adhesive, acrylic resin adhesive, cyanoacrylate adhesive, and combinations thereof.

In various aspects, the present disclosure provides an electrochemical cell that cycles lithium ions. The electrochemical cell may include a first current collector, a second current collector parallel with the first current collector, a first polymer blocker connecting a first side or edge of the first current collector to a first side or edge of the second current collector, and a second polymer blocker connecting a second side or edge of the first current collector and a second side or edge of the second current collector to form a sealed area defined by the first current collector, the second current collector, the first polymer blocker, and the second polymer blocker. The first and second polymer blockers may include a polymeric layer, a first adhesive layer including a first adhesive and is disposed on or near a first surface of the polymeric layer, and a second adhesive layer including a second adhesive and is disposed on or near a second surface of the polymeric layer. The polymeric layer may have a porosity greater than or equal to about 50 vol. % to less than or equal to about 95 vol. %. A portion of the first adhesive impregnating a first portion of the polymeric layer, and a portion of the second adhesive impregnating a second portion of the polymeric layer. The first and second portions may be the same or different. The second surface of the polymeric layer may be parallel with the first surface of the polymeric layer.

In one aspect, the sealed area may include a positive electroactive material layer, a negative electroactive material layer, and an electrolyte layer disposed between and physically separating the positive electroactive material layer and the negative electroactive material layer.

In one aspect, the electrolyte layer may include a polymeric gel electrolyte.

In one aspect, at least one of the positive electroactive material layer and the negative electroactive material layer may include a polymeric gel electrolyte.

In one aspect, the first and second adhesive may together fill greater than or equal to about 80% to less than or equal to about 100% of a total porosity of the polymeric layer.

In one aspect, the polymeric layer may include a material selected from the group consisting of: polyester nonwoven separator, cellulose separator, polyvinylidene fluoride (PVDF) membrane, polyimide membrane, polyolefin-based separator, ceramic-coating separator, high-temperature stable separator, oxide particle layers, and combinations thereof.

In one aspect, at least one of the first and second adhesives may include a hot-melt adhesive.

In one aspect, at least one of the first and second adhesives may include an amorphous polypropylene resin prepared by copolymerizing at least two of ethylene, propylene, and butene.

In one aspect, the first and second adhesives may be independently selected from the group consisting of: polyethylene resin, polypropylene resin, polybutylene resin, urethane resin, polyamide resin, ethylene, propylene, butene, silicon, polyimide resin, epoxy resin, acrylic resin, ethylene-propylenediene rubber (EPDM), isocyanate adhesive, acrylic resin adhesive, cyanoacrylate adhesive, and combinations thereof.

In various aspects, the present disclosure provides a method for forming a polymer blocker for use in an electrochemical battery that cycles lithium ions. The method may include hot pressing a precursor polymer blocker. The hot pressing may include applying a pressure greater than or equal to about 10 MPa to less than or equal to about 300 MPa at a temperature greater than or equal to about 100° C. to less than or equal to about 300° C. The precursor polymer blocker may include a polymeric layer, a first precursor adhesive layer including a first adhesive and is disposed on or near a first surface of the polymeric layer, and a second precursor adhesive layer including a second adhesive and is disposed on or near a second surface of the polymeric layer. The polymeric layer may have a porosity greater than or equal to about 50 vol. % to less than or equal to about 95 vol. %. After the hot pressing, the first precursor adhesive layer may form a first adhesive layer that includes a portion of the first adhesive that impregnates a first portion of the polymeric layer. After the hot pressing, the second precursor adhesive layer may form a second adhesive layer that includes a portion of the second adhesive that impregnates a second portion of the polymeric layer. The first and second portions of the polymeric layer may be the same or different.

In one aspect, the first and second precursor adhesive layers may have average thicknesses greater than or equal to about 500 μm to less than or equal to about 700 μm. The first and second adhesive layers may have average thicknesses greater than or equal to about 5 μm to less than or equal to about 200 μm.

In one aspect, the first and second adhesives may together fill greater than or equal to about 80% to less than or equal to about 100% of a total porosity of the polymeric layer.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example solid-state battery including polymer blockers in accordance with various aspects of the present disclosure;

FIG. 2 is an illustration of an example polymer blocker in accordance with various aspects of the present disclosure;

FIG. 3 is a flowchart illustrating an example method for forming a polymer blocker in accordance with various aspects of the present disclosure;

FIG. 4A illustrates an example method for forming a bipolar solid-state battery including a plurality of battery cells and a plurality of polymer blockers in accordance with various aspects of the present disclosure;

FIG. 4B illustrates an example method for forming a bipolar solid-state battery including a plurality of battery cells and a plurality of polymer blockers in accordance with various aspects of the present disclosure;

FIG. 5A is a graphical illustration demonstrating charge-discharge capacity of an example battery including polymer blockers in accordance with various aspects of the present disclosure;

FIG. 5B is a graphical illustration demonstrating capacity retention and efficiency of an example battery including polymer blockers in accordance with various aspects of the present disclosure; and

FIG. 5C is a graphical illustration demonstrating aging of an example battery including polymer blockers in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The current technology pertains to solid-state batteries (SSBs) and methods of forming and using the same. Solid-state batteries may include at least one solid component, for example, at least one solid electrode, but may also include, in certain variations, semi-solid or gel, liquid, or gas components. In certain variations, solid-state batteries may have a bipolar stacking design comprising a plurality of bipolar electrodes where a first mixture of solid-state electroactive material particles (and optional solid-state electrolyte particles) is disposed on a first surface of a current collector, and a second mixture of solid-state electroactive material particles (and optional solid-state electrolyte particles) is disposed on a second surface of a current collector that is parallel with the first surface. The first mixture may include, as the solid-state electroactive material particles, cathode material particles. The second mixture may include, as solid-state electroactive material particles, anode material particles. The solid-state electrolyte particles in each instance may be the same or different.

Such solid-state batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. In various aspects, the present disclosure provides a rechargeable lithium-ion battery that exhibits high temperature tolerance, as well as improved safety and superior power capability and life performance.

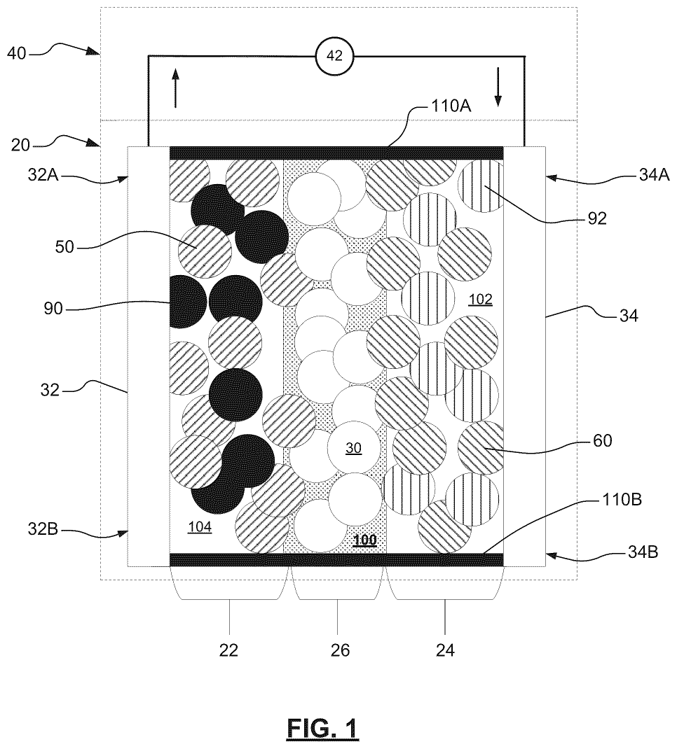

An exemplary and schematic illustration of a solid-state electrochemical cell unit (also referred to as a “solid-state battery” and/or “battery”) 20 that cycles lithium ions is shown in FIG. 1. The battery 20 includes a negative electrode (i.e., anode) 22, a positive electrode (i.e., cathode) 24, and an electrolyte layer 26 that occupies a space defined between the two or more electrodes. The electrolyte layer 26 is a solid-state or semi-solid state separating layer that physically separates the negative electrode 22 from the positive electrode 24. The electrolyte layer 26 may include a first plurality of solid-state electrolyte particles 30. A second plurality of solid-state electrolyte particles 90 may be mixed with negative solid-state electroactive particles 50 in the negative electrode 22, and a third plurality of solid-state electrolyte particles 92 may be mixed with positive solid-state electroactive particles 60 in the positive electrode 24, so as to form a continuous lithium-ion conduction network.

A first current collector 32 may be positioned at or near the negative electrode 22. The first current collector 32 together with the negative electrode 22 may be referred to as a negative electrode assembly. In certain variations, the first current collector 32 may be a metal foil, metal grid or screen, or expanded metal comprising copper, stainless steel, nickel, iron, titanium, or any other appropriate electrically conductive material known to those of skill in the art. In certain variations, the first current collector 32 may be coated foil having improved corrosion resistance, such as graphene or carbon coated stainless steel foil.

A second current collector 34 may be positioned at or near the positive electrode 24. The second current collector 34 together with the positive electrode 24 may be referred to as a positive electrode assembly. In certain variations, the second current collector 34 may be a metal foil, metal grid or screen, or expanded metal comprising stainless steel, aluminum, nickel, iron, titanium, or any other appropriate electrically conductive material known to those of skill in the art. In certain variations, the second current collector 32 may be coated foil having improved corrosion resistance, such as graphene or carbon coated stainless steel foil.

Although not illustrated, the skilled artisan will recognize that in certain variations, the first current collector 32 may be a first bipolar current collector and/or the second current collector 34 may be a second bipolar current collector. For example, the first bipolar current collector 32 and/or the second bipolar current collector 34 may be a cladded foil, for example, where one half (e.g., the first half or the second half) of the current collector 32, 34 includes one metal (e.g., first metal) and another half (e.g., the other half of the first half or the second half) of the current collector 32 includes another metal (e.g., second metal). The cladded foil may include, for example only, aluminum-copper (Al—Cu), nickel-copper (Ni—Cu), stainless steel-copper (SS-Cu), aluminum-nickel (Al—Ni), aluminum-stainless steel (Al-SS), and nickel-stainless steel (Ni-SS). In certain variations, the first bipolar current collector 32 and/or second bipolar current collectors 34 may be pre-coated, such as graphene or carbon-coated aluminum current collectors.

In each variation, the first current collector 32 may have an average thickness greater than or equal to about or exactly 2 μm to less than or equal to about 30 μm, and the second current collector 34 may have an average thickness greater than or equal to about or exactly 2 μm to less than or equal to about or exactly 30 μm. The first current collector 32 and the second electrode current collector 34 respectively collect and move free electrons to and from an external circuit 40. For example, an interruptible external circuit 40 and a load device 42 may connect the negative electrode 22 (through the first current collector 32) and the positive electrode 24 (through the second current collector 34).

The battery 20 can generate an electric current (indicated by arrows in FIG. 1) during discharge by way of reversible electrochemical reactions that occur when the external circuit 40 is closed (to connect the negative electrode 22 and the positive electrode 24) and when the negative electrode 22 has a lower potential than the positive electrode 24. The chemical potential difference between the negative electrode 22 and the positive electrode 24 drives electrons produced by a reaction, for example, the oxidation of intercalated lithium, at the negative electrode 22, through the external circuit 40 towards the positive electrode 24. Lithium ions, which are also produced at the negative electrode 22, are concurrently transferred through the electrolyte layer 26 towards the positive electrode 24. The electrons flow through the external circuit 40 and the lithium ions migrate across the electrolyte layer 26 to the positive electrode 24, where they may be plated, reacted, or intercalated. The electric current passing through the external circuit 40 can be harnessed and directed through the load device 42 (in the direction of the arrows) until the lithium in the negative electrode 22 is depleted and the capacity of the battery 20 is diminished.

The battery 20 can be charged or reenergized at any time by connecting an external power source (e.g., charging device) to the battery 20 to reverse the electrochemical reactions that occur during battery discharge. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator. The connection of the external power source to the battery 20 promotes a reaction, for example, non-spontaneous oxidation of intercalated lithium, at the positive electrode 24 so that electrons and lithium ions are produced. The electrons, which flow back towards the negative electrode 22 through the external circuit 40, and the lithium ions, which move across the electrolyte layer 26 back towards the negative electrode 22, reunite at the negative electrode 22 and replenish it with lithium for consumption during the next battery discharge cycle. As such, a complete discharging event followed by a complete charging event is considered to be a cycle, where lithium ions are cycled between the positive electrode 24 and the negative electrode 22.

Although the illustrated example includes a single positive electrode 24 and a single negative electrode 22, the skilled artisan will recognize that the current teachings apply to various other configurations, including those having one or more cathodes and one or more anodes, as well as various current collectors and current collector films with electroactive particle layers disposed on or adjacent to or embedded within one or more surfaces thereof. Likewise, it should be recognized that the battery 20 may include a variety of other components that, while not depicted here, are nonetheless known to those of skill in the art. For example, the battery 20 may include a casing, a gasket, terminal caps, and any other conventional components or materials that may be situated within the battery 20, including between or around the negative electrode 22, the positive electrode 24, and/or the electrolyte 26 layer.

In many configurations, each of the first current collector 32, the negative electrode 22, the electrolyte layer 26, the positive electrode 24, and the second current collector 34 are prepared as relatively thin layers (for example, from several microns to a millimeter or less in thickness) and assembled in layers connected in series arrangement to provide a suitable electrical energy, battery voltage and power package, for example, to yield a Series-Connected Elementary Cell Core (“SECC”). The size and shape of the battery 20 may vary depending on the particular applications for which it is designed. Battery-powered vehicles and hand-held consumer electronic devices are two examples where the battery 20 would most likely be designed to different size, capacity, voltage, energy, and power-output specifications. The battery 20 may also be connected in series with other similar lithium-ion cells or batteries to produce a greater voltage output, energy, and power if it is required by the load device 42.

The battery 20 can generate an electric current to the load device 42 that can be operatively connected to the external circuit 40. The load device 42 may be fully or partially powered by the electric current passing through the external circuit 40 when the battery 20 is discharging. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be an electricity-generating apparatus that charges the battery 20 for purposes of storing electrical energy.

With renewed reference to FIG. 1, the electrolyte layer 26 provides electrical separation—preventing physical contact—between the negative electrode 22 and the positive electrode 24. The electrolyte layer 26 also provides a minimal resistance path for internal passage of ions. The electrolyte layer 26 may have an average thickness greater than or equal to about or exactly 1 μm to less than or equal to about or exactly 1,000 μm, optionally greater than or equal to about or exactly 5 μm to less than or equal to about or exactly 200 μm, optionally greater than or equal to about or exactly 10 μm to less than or equal to about or exactly 100 μm, optionally about or exactly 20 μm, and in certain aspects, optionally about or exactly 15 μm.

In various aspects, the electrolyte layer 26 may be defined by a first plurality of solid-state electrolyte particles 30. For example, the electrolyte layer 26 may be in the form of a layer or a composite that comprises the first plurality of solid-state electrolyte particles 30. The solid-state electrolyte particles 30 may have an average particle diameter greater than or equal to about or exactly 0.02 μm to less than or equal to about or exactly 20 μm, optionally greater than or equal to about or exactly 0.1 μm to less than or equal to about or exactly 10 μm, and in certain aspects, optionally greater than or equal to about or exactly 0.1 μm to less than or equal to about or exactly 5 μm. In certain variations, the solid-state electrolyte particles may include oxide-based solid-state particles, metal-doped or aliovalent-substituted oxide solid-state particles, sulfide-based solid-state particles, nitride-based solid-state particles, hydride-base solid-state particles, halide-based solid-state particles, borate-based solid-state particles, and/or inactive solid-state oxide particles.

The oxide-based solid-state particles may include, for example only, garnet type solid-state particles (e.g., Li₇La₃Zr₂O₁₂), perovskite type solid-state particles (e.g., Li₃ₓLa_{2/3-x}TiO₃, where 0<x<0.167), NASICON type solid-state particles (e.g., Li_{1.4}Al_{0.4}Ti_{1.6}(PO₄)₃, Li₁₊ₓAlₓGe₂₋ₓ(PO₄)₃ (where 0≤x≤2) (LAGP)), and/or LISICON type solid-state particles (e.g., Li₂₊₂ₓZn₁₋ₓGeO₄, where 0<x<1). The metal-doped or aliovalent-substituted oxide solid-state particles may include, for example only, aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P₃O₁₂, and/or aluminum (Al) substituted Li_{1+x+y}AlₓTi₂₋ₓSi_{y}P_{3-y}O₁₂ (where 0<x<2 and 0<y<3). The sulfide-based solid-state particles may include, for example only, Li₂S—P₂S₅ systems, Li₂S—P₂S₅-MOₓ systems (where M is Zn, Ca, or Mg, and 0<x<3), Li₂S—P₂S₅-MSₓ systems (where M is Si, or Sn, and 0<x<3), Li₁₀GeP₂S₁₂ (LGPS), Li_{3.25}Ge_{0.25}P_{0.75}S₄ (thio-LISICON), Li_{3.4}Si_{0.4}P_{0.6}S₄, Li₁₀GeP₂Si_{11.7}O_{0.3}, lithium argyrodite (Li₆PS₅X, where X is Cl, Br, or I), Li_{9.54}Si_{1.74}P_{1.44}S_{11.7}Cl_{0.3}, Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.18}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.833}Sn_{0.833}AS_{0.166}S₄, LiI—Li₄SnS₄, and/or Li₄SnS₄. The nitride-based solid-state particles may include, for example only, Li₃N, Li₇PN₄, and/or LiSi₂N₃. The hydride-base solid-state particles may include, for example only, LiBH₄, LiBH₄—LiX (where X is Cl, Br, or I), LiNH₂, Li₂NH, LiBH₄—LiNH₄, and/or Li₃AlH₆. The halide-based solid-state particles may include, for example only, LiI, Li₃InCl₆, Li₂CdCl₄, Li₂MgCl₄, Li₂CdI₄, Li₂ZnI₄, and/or Li₃OCl. The borate-based solid-state particles may include, for example only, Li₂B₄O₇ and/or Li₂O—B₂O₃—P₂O₅. The inactive solid-state oxides particles include, for example only, SiO₂, Al₂O₃, TiO₂, and/or ZrO₂.

Although not illustrated, the skilled artisan will recognize that in certain instances, one or more binder particles may be mixed with the solid-state electrolyte particles 30. For example, in certain aspects, the electrolyte layer 26 may include greater than or equal to about or exactly 0 wt. % to less than or equal to about or exactly 10 wt. %, and in certain aspects, optionally greater than or equal to about or exactly 0.5 wt. % to less than or equal to about or exactly 10 wt. %, of the one or more binders. The one or more polymeric binders may include, for example only, polyvinylidene difluoride (PVDF), polytetrafluoroethylene (PTFE), ethylene propylene diene monomer (EPDM) rubber, nitrile butadiene rubber (NBR), styrene-butadiene rubber (SBR), and lithium polyacrylate (LiPAA).

In various aspects, as illustrated, the electrolyte layer 26 may further include a first polymeric gel electrolyte (e.g., a soft medium) 100 that wets interfaces and/or substantially fills voids (or pores, or spaces) between the solid-state electrolyte particles 30, thereby reducing interparticle porosity and improve ionic contact and/or enable higher power capabilities. For example, the first polymeric gel electrolyte 100 may fill greater than or equal to about or exactly 20 vol. % to less than or equal to about or exactly 100 vol. % of a total void volume in the electrolyte layer. The first polymeric gel electrolyte 100 includes a polymer host and a liquid electrolyte. For example, the first polymeric gel electrolyte 100 may include greater than or equal to about or exactly 0.1 wt. % to less than or equal to about or exactly 50 wt. % of the polymer host, and greater than or equal to about or exactly 5 wt. % to less than or equal to about or exactly 90 wt. % of the liquid electrolyte.

In certain variations, the polymer host may be selected from the group consisting of: polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof.

The liquid electrolyte includes a lithium salt and a solvent. For example, the liquid electrolyte may have a salt concentration of greater than or equal to about or exactly 0.5 M to less than or equal to about or exactly 5.0 M. The lithium salt includes a lithium cation (Lit) and one or more anions. In certain variations, the anion(s) may be selected from the group consisting of: hexafluoroarsenate, hexafluorophosphate, bis(fluorosulfonyl)imide (FSI), perchlorate, tetrafluoroborate, cyclo-difluoromethane-1,1-bis(dulfonyl)imide (DMSI), bis(trifluoromethanesulfonyl)imide (TFSI), bis(pentafluoroethanesulfonyl)imide (BETI), bis(oxalate)borate (BOB), difluoro(ocalato)borate (DFOB), bis(fluoromalonato)boarate (BFMB), and combinations thereof.

The solvent dissolves the lithium salt to enable good lithium ion conductivity. In certain variations, the solvent includes, for example only, carbonate solvents (such as, ethylene carbonate (EC), propylene carbonate (PC), glycerol carbonate, vinylene carbonate, fluoroethylene carbonate, 1,2-butylene carbonate, and the like), lactones (such as, γ-butyrolactone (GBL), δ-valerolactone, and the like), nitriles (such as, succinonitrile, glutaronitrile, adiponitrile, and the like), sulfones (such as, tetramethylene sulfone, ethyl methyl sulfone, vinyl sulfone, phenyl sulfone, 4-fluorophenyl sulfone, benzyl sulfone, and the like), ethers (such as, triethylene glycol dimethylether (triglyme, G3), tetraethylene glycol dimethylether (tetraglyme, G4), 1,3-dimethyoxy propane, 1,4-dioxane, and the like), and/or phosphates (such as, triethyl phosphate, trimethyl phosphate, and the like). In certain variations, the solvent is an ionic liquid that includes ionic liquid cations and ionic liquid anions. The ionic liquid cations may include, for example only, 1-ethyl-3-methylimidazolium ([Emim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), and/or 1-butyl-1-methylpyrrolidinium ([Pyr₁₄]⁺. The ionic liquid anions may include, for example only, bis(trifluoromethanesulfonyl)imide (TFSI) and/or bis(fluorosulfonyl imide (FS).

Although not illustrated, the skilled artisan will understand that, in certain variations, the electrolyte layer 26 may be a free-standing membrane formed from the first polymeric gel electrolyte 100 and omitting solid-state electrolyte particles 30. That is, the electrolyte layer 26 may be self-supporting layer having structural integrity that can be handled as an independent layer.

The positive electrode 24 (also referred to as a positive electroactive material layer) is defined by a plurality of the positive solid-state electroactive particles 60. In certain instances, as illustrated, the positive electrode 24 is a composite comprising a mixture of the positive solid-state electroactive particles 60 and a third plurality of solid-state electrolyte particles 92. For example, the positive electrode 24 may include greater than or equal to about or exactly 30 wt. % to less than or equal to about or exactly 98 wt. %, and in certain aspects, optionally greater than or equal to about or exactly 50 wt. % to less than or equal to about or exactly 95 wt. %, of the positive solid-state electroactive particles 60, and greater than or equal to about or exactly 0 wt. % to less than or equal to about or exactly 50 wt. %, and in certain aspects, optionally greater than or equal to about or exactly 5 wt. % to less than or equal to about or exactly 20 wt. %, of the third plurality of solid-state electrolyte particles 92. In each variation, the positive electrode 24 may be in the form of a layer having an average thickness greater than or equal to about or exactly 10 μm to less than or equal to about or exactly 400 μm, optionally greater than or equal to about or exactly 10 μm to less than or equal to about or exactly 100 μm, and in certain aspects, optionally about 40 μm.

In certain variations, the positive electrode 24 may be one of a layered-oxide cathode, a spinel cathode, a polyanion cathode, and an olivine cathode. In the instances of the layered-oxide cathode (e.g., rock salt layered oxides), the positive solid-state electroactive particles 60 may include one or more positive electroactive materials selected from LiCoO₂, LiNiₓMn_{y}Co_{1-x-y}O₂ (where 0≤x≤1 and 0≤y≤1), LiNiₓMn_{y}Al_{1-x-y}O₂ (where 0<x≤1 and 0<y≤1), LiNiₓMn_{y}Co_{z}Al_{1-x-y-z}O₂ (where 0≤x≤1, 0≤y≤1, and 0≤z≤1), LiNiₓMn₁₋ₓO₂ (where 0≤x≤1), and Li₁₊ₓMO₂ (where 0≤x≤1). In the instance of the spinel cathode, the positive solid-state electroactive particles 60 may include positive electroactive materials like LiMn₂O₄ and LiNi_{0.5}Mn_{1.5}O₄. In the instance of the polyanion cathode, the positive solid-state electroactive particles 60 may include positive electroactive materials like LiFePO₄, LiVPO₄, LiV₂(PO₄)₃, Li₃Fe₃(PO₄)₄, and Li₃V₂(PO₄)F₃. In the instance of the olivine cathode, the positive solids-state electroactive particles 60 may include positive electroactive materials like Li₂FePO₄ and LiMnₓFe ₁₋ₓ PO₄ (where 0.6<x≤0.8). In other variations, the positive electrode 24 may include a low-voltage (e.g., <3 V vs. Li/Li+) cathode material, like lithium metal oxide/sulfide (such as, LiTiS₂) lithium sulfide, sulfur, and the like. In each variation, the positive solid-state electroactive particles 60 may be coated (for example, by LiNbO₃ and/or Al₂O₃) and/or the positive electroactive material may be doped (for example, by aluminum and/or magnesium).

The third plurality of solid-state electrolyte particles 92 may be the same as or different form the first plurality of solid-state electrolyte particles 30. In certain variations, as illustrated, the positive electrode 24 may further include a second polymeric gel electrolyte (e.g., a semi-solid electrolyte or soft medium) 102 that wets interfaces and/or substantially fills voids (or pores, or spaces) between the positive solid-state electroactive particles 60, and also, between the positive solid-state electroactive particles 60 and the optional solid-state electrolyte particles 92, thereby reducing interparticle porosity and improve ionic contact and/or enable higher power capabilities. For example, in certain variations, the second polymeric gel electrolyte 102 may fill greater than or equal to about or exactly 20 vol. % to less than or equal to about or exactly 100 vol. % of a total void volume in the positive electrode 24. Like the first polymeric gel electrolyte 100, the second polymeric gel electrolyte 102 includes a polymer host and a liquid electrolyte. The second polymeric gel electrolyte 102 may be the same as or different form the first polymeric gel electrolyte 100.

Although not illustrated, in certain variations, the positive electrode 24 may further include one or more additives, for example conductive additives and/or binder additives. For example, the positive electrode 24 may include greater than or equal to about or exactly 0 wt. % to less than or equal to about or exactly 30 wt. %, and in certain aspects, optionally greater than or equal to about or exactly 0 wt. % to less than or equal to about or exactly 10 wt. %, of the conductive additives; and greater than or equal to about or exactly 0 wt. % to less than or equal to about 20 wt. %, and in certain aspects, optionally greater than or equal to about or exactly 0 wt. % to less than or equal to about or exactly 10 wt. %, of the binder additives.

Conductive additives may include, for example only, carbon-based materials like graphite, acetylene black (such as KETCHEN™ black or DENKA™ black), carbon nanofibers and nanotubes, graphene (such as graphene oxide), and/or carbon black (such as Super P). Binder additives may include, for example only, polyvinylidene difluoride (PVDF), poly(vinylidene fluoride-co-hexafluoropropylene (PVDF-HFP), polytetrafluoroethylene (PTFE), sodium carboxymethyl cellulose (CMC), ethylene propylene diene monomer (EPDM) rubber, nitrile butadiene rubber (NBR), styrene-butadiene rubber (SBR), styrene ethylene butylene styrene copolymers (SEBS), styrene butadiene styrene copolymers (SBS), polyethylene glycol (PEO), and/or lithium polyacrylate (LiPAA).

The negative electrode 22 (also referred to as a negative electroactive material layer) is defined by a plurality of negative solid-state electroactive particles 50. In certain instances, as illustrated, the negative electrode 22 is a composite comprising a mixture of the negative solid-state electroactive particles 50 and a second plurality of solid-state electrolyte particles 90. For example, the negative electrode 22 may include greater than or equal to about or exactly 30 wt. % to less than or equal to about or exactly 98 wt. %, and in certain aspects, optionally greater than or equal to about or exactly 50 wt. % to less than or equal to about or exactly 95 wt. %, of the negative solid-state electroactive particles 50, and greater than or equal to about or exactly 0 wt. % to less than or equal to about or exactly 50 wt. %, and in certain aspects, optionally greater than or equal to about or exactly 5 wt. % to less than or equal to about or exactly 20 wt. %, of the third plurality of solid-state electrolyte particles 90. In each variation, the negative electrode 22 may be in the form of a layer having an average thickness greater than or equal to about or exactly 10 μm to less than or equal to about or exactly 500 μm, optionally greater than or equal to about or exactly 10 μm to less than or equal to about or exactly 100 μm, and in certain aspects, optionally about 40 μm.

In certain variations, the negative solid-state electroactive particles 50 may be lithium-based, for example, a lithium alloy or lithium metal. In other variations, the negative solid-state electroactive particles 50 may be silicon-based comprising, for example, a silicon alloy and/or silicon-graphite mixture. In still other variations, the negative electrode 22 may be a carbonaceous anode and the negative solid-state electroactive particles 50 may comprise one or more negative electroactive materials, such as graphite, graphene, hard carbon, soft carbon, and carbon nanotubes (CNTs). In still further variations, the negative electrode 22 may comprise one or more negative electroactive materials, such as lithium titanium oxide (Li₄Ti₅O₁₂); one or more metal oxides, such as TiO₂ and/or V₂O₅; and/or metal sulfides, such as FeS.

The second plurality of solid-state electrolyte particles 90 may be the same as or different form the first plurality of solid-state electrolyte particles 30 and/or the third plurality of solid-state electrolyte particles 92. In certain variations, as illustrated, the negative electrode 22 may further include a third polymeric gel electrolyte (e.g., a semi-solid electrolyte or soft medium) 104 that wets interfaces and/or substantially fills voids (or pores, or spaces) between the negative solid-state electroactive particles 50, and also, between the negative solid-state electroactive particles 50 and the optional solid-state electrolyte particles 90, thereby reducing interparticle porosity and improve ionic contact and/or enable higher power capabilities. For example, the third polymeric gel electrolyte 104 may fill greater than or equal to about or exactly 20 vol. % to less than or equal to about or exactly 100 vol. % of a total void volume in the negative electrode 22. Like the first polymeric gel electrolyte 100 and the second polymeric gel electrolyte 102, the third polymeric gel electrolyte 104 includes a polymer host and a liquid electrolyte. The third polymeric gel electrolyte 104 may be the same as or different form the first polymeric gel electrolyte 100 and/or the second polymeric gel electrolyte 102.

Although not illustrated, in certain variations, the negative electrode 22 may further include one or more additives, for example conductive additives and/or binder additives. For example, the negative electrode 22 may include greater than or equal to about or exactly 0 wt. % to less than or equal to about or exactly 30 wt. %, and in certain aspects, optionally greater than or equal to about or exactly 0 wt. % to less than or equal to about or exactly 10 wt. %, of the conductive additives; and greater than or equal to about or exactly 0 wt. % to less than or equal to about 20 wt. %, and in certain aspects, optionally greater than or equal to about or exactly 0 wt. % to less than or equal to about or exactly 10 wt. %, of the binder additives. The conductive additives and binder additives may be the same as or different form the conductive additives included in the positive electrode 24.

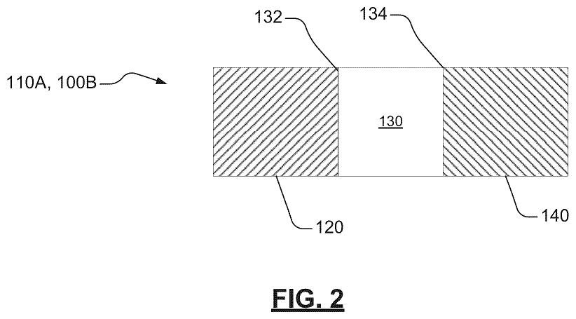

The battery 20 further includes one or more polymer blockers 110A, 110B configured to seal individual cell units and prevent or reduce leakage of the polymer gel electrolytes 100, 102, 104. The polymer blockers 110A, 110B are configured to bond to boarders of opposing current collectors 32, 34. For example, as illustrated, the battery 20 may include a first polymer blocker 110A extending between a first end or side 32A of the first current collector 32 and a first end or side 34A of the second current collector 34, which seals a first side of the cell unit; and a second polymer blocker 110B extending between a second end or side 32B of the first current collector 32 and a second end or side 34B of the second current collector 34, which seals a second side of the cell unit. Each of the polymer blockers 110A, 110B includes an adhesive and a polymeric structure or framework. For example, as illustrated in FIG. 2, the polymer blockers 110A, 110B may have a sandwich structure, where a first adhesive layer 120 is disposed on or adjacent to a first surface 132 of a polymeric layer 130, and a second adhesive layer 140 is disposed on or adjacent to second surface 134 of the polymeric layer 130. The polymer blockers 110A, 110B may have average thicknesses greater than or equal to about or exactly 2 μm to less than or equal to about or exactly 400 μm, and in certain aspects, optionally greater than or equal to about 150 μm to less than or equal to about 200 μm.

The polymer blockers 110A, 100B should be ionically/electrically insulating and have strong adhesion forces to metal current collectors (like the first and second current collectors 32, 24), as well as excellent thermostability. In certain variations, the first adhesive layer 120 and/or the second adhesive layer 140 includes a hot-melt adhesive. In certain variations, hot-melt adhesives may increase flowabilities at temperatures greater than or equal to about or exactly 100° C. to less than or equal to about or exactly 300° C., and in certain aspects, optionally about or exactly 150° C. Example hot-melt adhesives include polyolefins (such as, polyethylene resin, polypropylene resin, and/or polybutylene resin), urethane resin, and/or polyamide resin. In other variations, the first adhesive layer 120 and/or the second adhesive layer 140 includes an amorphous polypropylene resin as a main component, where the amorphous polypropylene resin is prepared by copolymerizing ethylene, propylene, and/or butene. In still other variations, the first adhesive layer 120 and/or the second adhesive layer 140 includes silicon, polyimide resin, epoxy resin, acrylic resin, rubber (e.g., ethylene-propylenediene rubber (EPDM)), isocyanate adhesive, acrylic resin adhesive, and/or cyanoacrylate adhesive. The first and second adhesive layers 120, 140 may have average thicknesses greater than or equal to about or exactly 5 μm to less than or equal to about or exactly 200 μm, and in certain aspects, optionally greater than or equal to about 5 μm to less than or equal to about 100 μm.

The polymeric layer 130 is a porous layer having a porosity (of open pores) of greater than or equal to about or exactly 50 vol. % to less than or equal to about or exactly 95 vol. %, and in certain aspects, optionally greater than or equal to about or exactly 60 vol. % to less than or equal to about or exactly 95 vol. %. One or more portions of the total open pores of the polymeric layer 130 may be impregnated with the first adhesive defining the first adhesive layer and/or the second adhesive defining the second adhesive layer. For example, the first and second adhesives may fill greater than or equal to about or exactly 80 vol % to less than or equal to about or exactly 100 vol % of a total porosity of the polymeric layer 130.

In certain variation, the polymeric layer 130 includes a material such as polyester nonwoven separator, cellulose separator, polyvinylidene fluoride (PVDF) membrane, polyimide membrane, polyolefin-based separator (e.g., polyacetylene, polypropylene (PP), polyethylene (PE), and/or dual-layered type (such as, polypropylene (PP): polyethylene (PE)), and/or three-layer type (such as, polypropylene (PP): polyethylene (PE): polypropylene (PP))), ceramic-coating separator (e.g., silicon oxide (SiO₂) coated polyethylene (PE)), high-temperature stable separator (e.g., polyimide (PI) nanofiber-base nonwovens, co-polyimide-coated polyethylene separators, expanded polytetrafluoroethylene reinforced polyvinylidenefluoride-hexafluoropropylene separator, and/or sandwich-structured polyvinylidene fluoride (PVDF): poly(m-phenylene isophthalamide): polyvinylidene fluoride (PVDF) nanofibrous separator), and/or oxide particle layers (e.g., SiO₂, Al₂O₃, TiO₂, and/or ZrO₂). In each instance, the polymeric layer 130 may have an average thickness greater than or equal to about or exactly 2 μm to less than or equal to about or exactly 100 μm, and in certain aspects, optionally greater than or equal to about 5 μm to less than or equal to about 30 μm. The polymeric layer 130 physically supports the first and second adhesive layers 120, 140 inhibiting electrical short-circuit during sealing of cell unit during battery fabrication (e.g., above about 130° C.).

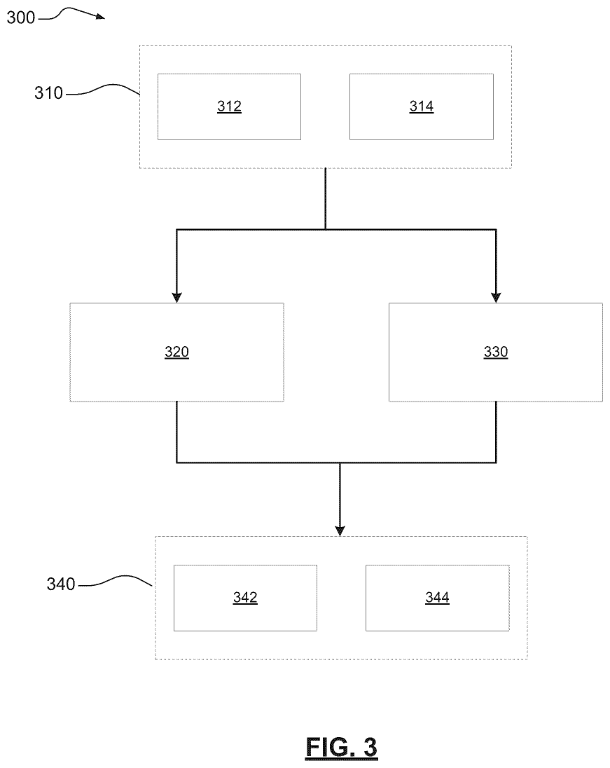

In various aspects, the present disclosure provides methods for forming polymer blockers. For example, FIG. 3 illustrates an example method 300 for forming a polymer blocker, like the polymer blockers 110A, 110B illustrated in FIG. 1. The method 300 may include disposing 320 a first precursor adhesive layer on or near a first surface of a precursor porous, polymeric layer, and disposing 330 a second precursor adhesive layer one or near a second surface of the precursor polymeric layer. The disposing 320 of the first precursor adhesive layer on or near the first surface of the precursor polymeric layer, and the disposing 330 of the second precursor adhesive layer on or near the second surface of the precursor polymeric layer may occur simultaneously or concurrently. In certain variation, the disposing 320 of the first precursor adhesive layer on or near the first surface of the precursor polymeric layer, and the disposing 330 of the second precursor adhesive layer on or near the second surface of the precursor polymeric layer may include, for example, a direct physical connection process. The precursor polymeric layer together with the first and second precursor adhesive layers may be referred to as a precursor blocker structure.

The method 300 further includes hot pressing 340 the precursor blocker structure to form the polymer blocker. The hot pressing 340 may include heating 342 the precursor blocker structure to a temperature greater than or equal to about or exactly 100° C. to less than or equal to about or exactly 300° C., and in certain aspects, optionally about or exactly 180° C., and disposing 342 the precursor blocker structure within a die or press and using the die or press to apply a pressure 344 greater than or equal to about or exactly 10 MPa to less than or equal to about or exactly 300 MPa, and in certain aspects, optionally greater than or equal to about or exactly 10 MPa to less than or equal to about or exactly 200 MPa. The heating 342 and the application of pressure using a die or press 344 may occur simultaneously or concurrently, where the precursor blocker structure is heated prior to placement within the die or press and application of the pressure, or where the precursor blocker structure is disposed within the die or press and heated prior to the application of the pressure.

The hot pressing 340 may cause a portion of a first adhesive defining the first precursor adhesive layer and/or a portion of the second adhesive defining the second precursor adhesive layer to enter and/or fill a portion of the pores in the precursor polymeric layer, forming a first adhesive layer, a polymeric layer, and a second adhesive layer. The precursor blocker structure may have an average thickness greater than or equal to about or exactly 5 μm to less than or equal to about or exactly 450 μm, where the polymer blocker has an average thickness greater than or equal to about or exactly 2 μm to less than or equal to about or exactly 400 μm, and in certain aspects, optionally greater than or equal to about 150 μm to less than or equal to about 200 μm.

In certain variations, the method 300 may include preparing 310 the first and second precursor adhesive layers. Preparing 310 the first and second precursor adhesive layer may include heating 312 an untreated or raw adhesive layer to a temperature greater than or equal to about or exactly 100° C. to less than or equal to about or exactly 300° C., and in certain aspects, optionally about or exactly 180° C., and disposing the untreated or raw adhesive layer within a die or press and using the die or press to apply a pressure 314 greater than or equal to about or exactly 10 MPa to less than or equal to about or exactly 300 MPa, and in certain aspects, optionally greater than or equal to about or exactly 10 MPa to less than or equal to about or exactly 200 MPa. The heating 312 and the application of pressure using a die or press 314 may occur simultaneously or concurrently, where the untreated or raw adhesive layer is heated prior to placement within the die or press and application of the pressure, or where the untreated or raw adhesive layer is disposed within the die or press and heated prior to the application of the pressure. The untreated or raw adhesive layer may have an average thickness greater than or equal to about or exactly 500 μm to less than or equal to about or exactly 700 μm, where the first and second precursor adhesive layers may have average thicknesses greater than or equal to about or exactly 100 μm to less than or equal to about or exactly 200 μm.

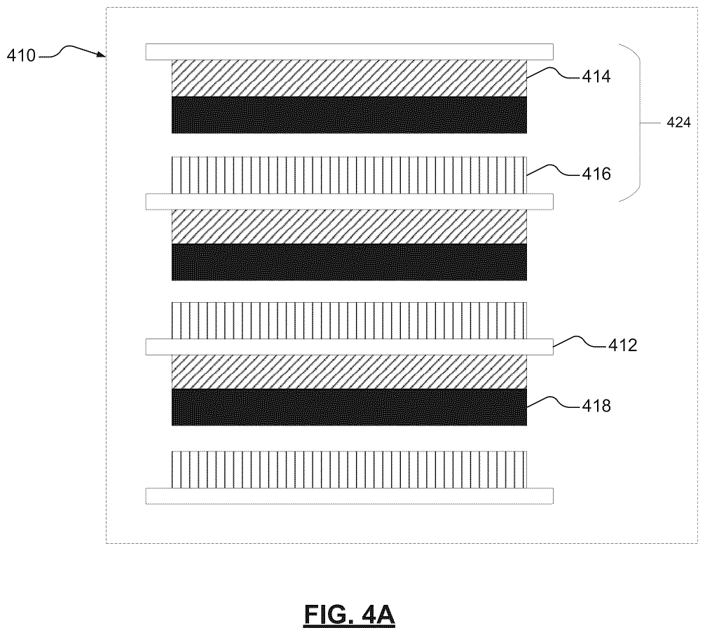

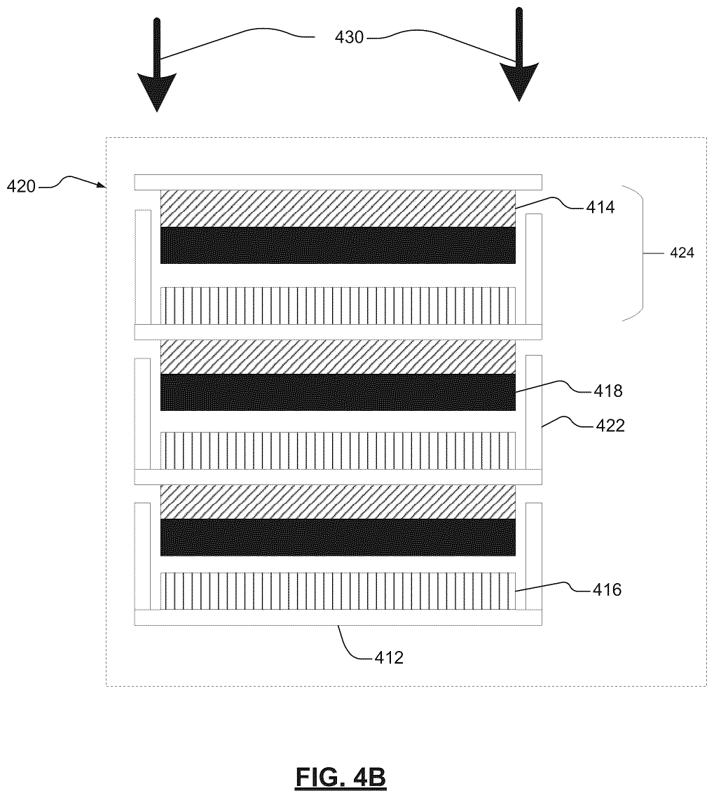

In various aspects, the present disclosure provides methods for forming a bipolar solid-state battery including a plurality of battery cells and a plurality of polymer blockers. For example, FIGS. 4A-4B illustrates an example method for forming a bipolar solid-state battery including a plurality of battery cells and a plurality of polymer blockers. In certain variations, as illustrated in FIG. 4A, the method includes aligning 410 battery components, including, for example, one or more current collectors 412 (like the first current collector 32 and/or second current collector 34 illustrated in FIG. 1), one or more negative electroactive material layers 414 (like the negative electrodes 32 illustrated in FIG. 1), one or more positive electroactive material layers 416 (like the positive electrodes 34 illustrated in FIG. 1), and one or more separators or solid-state electrolyte layers 418 (like the electrolyte layer 26 illustrated in FIG. 1) that physically separate adjacent negative and positive electroactive material layers 414, 416, to form a plurality of cell units 424. In certain variations, aligning 419 the battery components may include conventional stacking processes.

As illustrated in FIG. 4B, the method includes disposing 420 polymer blockers 422 along the open edges of the respective cell units 424 to form a precursor structure, and hot pressing 430 the outmost borders of the precursor structure to form the bipolar solid-state battery. In certain variations, the hot pressing 430 may include heating the precursor structure to a temperature greater than or equal to about or exactly 100° C. to less than or equal to about or exactly 300° C., and in certain aspects, optionally about or exactly 150° C., and applying a pressure greater than or equal to about or exactly 10 MPa to less than or equal to about or exactly 300 MPa, and in certain aspects, optionally greater than or equal to about or exactly 10 MPa to less than or equal to about or exactly 200 MPa. The heating and the application of pressure may occur simultaneously or concurrently, where the precursor structure is heated prior to the application of pressure, or where precursor structure is heated during the application of pressure. In each instance, the polymer blocker 422 will strongly adhere to adjacent current collectors 412.

Certain features of the current technology are further illustrated in the following non-limiting examples.

### Example 1

Example battery cells may be prepared in accordance with various aspects of the present disclosure. For example, an example bipolar battery 510 may be prepared that includes polymer blockers that are configured to seal each battery cell unit in accordance with various aspects of the present disclosure. A comparative battery 520 may have a similar cell unit configuration as the example battery 510 but excluding the polymer blockers.

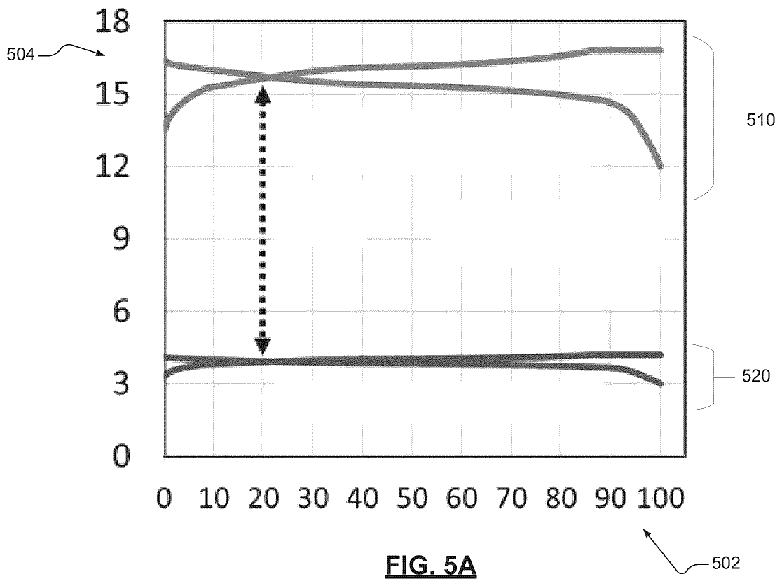

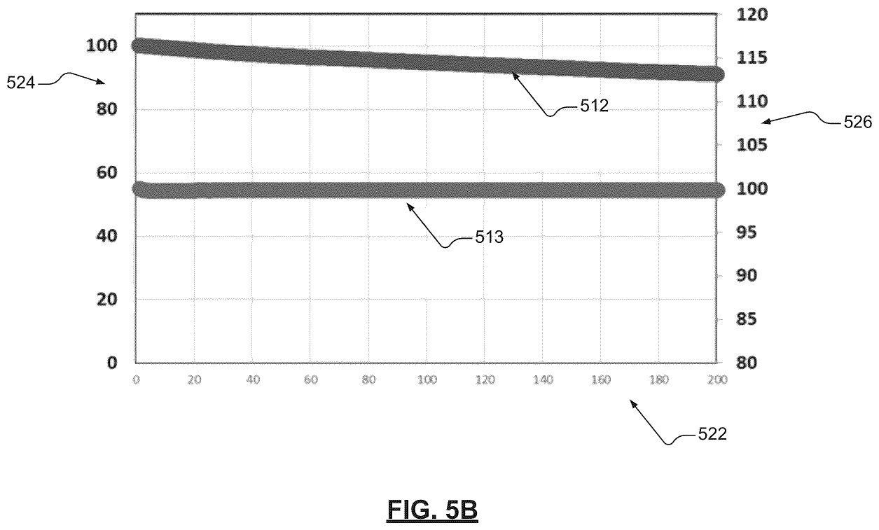

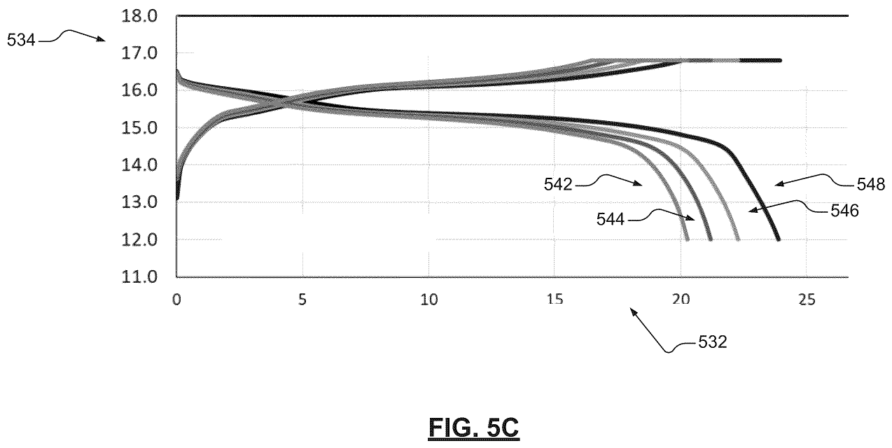

FIG. 5A is a graphical illustration demonstrating charge-discharge capacity of the example bipolar battery 510 as compared to the comparative battery 520 (cell unit) at 25° C., where the x-axis 502 represents state of charge (%) and the y-axis 504 represents voltage (V). As illustrated, the example bipolar battery 510 has demonstrated a four-times increased voltage profile, as compared to the example battery 520, indicating there is no ionic short-circuit for bipolar battery 510.

FIG. 5B is a graphical illustrating demonstrating capacity retention and efficiency of the example bipolar battery 510 at 25° C., where the x-axis 522 represents cycle number, the y₁-axis 524 represents capacity retention (%), the y₂-axis 526 represents Coulombic efficiency (%). Line 512 represents the capacity retention (%), while line 514 represents Coulombic efficiency. As illustrated, the example bipolar battery 510 has excellent capacity retention, and also, high Coulombic efficiency.

FIG. 5C is a graphical illustrating demonstrating the aging of the example bipolar battery 510 at 45° C., where the x-axis 532 represents capacity (mAh) and the y-axis 534 represents voltage (V). Line 542 represents the voltage after 1,530 cycles. Line 544 represents the voltage after 1,020 cycles. Line 546 represents the voltage after 510 cycles. Line 548 represents the voltage for a fresh cell. As illustrated, the example bipolar battery 510 has stable performance at 45° C.—that is, without ionic and electrical short-circuit—and can also deliver a high (e.g., 99.9%) Coulombic efficiency.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A polymer blocker for use in an electrochemical battery that cycles lithium ions, the polymer blocker comprising:
a polymeric layer having a porosity greater than or equal to about 50 vol. % to less than or equal to about 95 vol. %;
a first adhesive layer comprising a first adhesive and disposed on or near a first surface of the polymeric layer, a portion of the first adhesive impregnating a first portion of the polymeric layer; and
a second adhesive layer comprising a second adhesive and disposed on or near a second surface of the polymeric layer, the second surface of the polymeric layer being parallel with the first surface of the polymeric layer, a portion of the second adhesive impregnating a second portion of the polymeric layer, the first and second portions of the polymeric layer being the same or different.

2. The polymer blocker of claim 1, wherein the first and second adhesives together fill greater than or equal to about 80% to less than or equal to about 100% of a total porosity of the polymeric layer.

3. The polymer blocker of claim 1, wherein the polymer blocker has an average thickness greater than or equal to about 2 μm to less than or equal to about 400 μm.

4. The polymer blocker of claim 1, wherein the polymeric layer has an average thickness greater than or equal to about 2 μm to less than or equal to about 100 μm.

5. The polymeric blocker of claim 1, wherein the polymeric layer comprises a material selected from the group consisting of: polyester nonwoven separator, cellulose separator, polyvinylidene fluoride (PVDF) membrane, polyimide membrane, polyolefin-based separator, ceramic-coating separator, high-temperature stable separator, oxide particle layers, and combinations thereof.

6. The polymeric blocker of claim 1, wherein at least one of the first and second adhesives comprises a hot-melt adhesive.

7. The polymeric blocker of claim 1, wherein at least one of the first and second adhesives comprises an amorphous polypropylene resin prepared by copolymerizing at least two of ethylene, propylene, and butene.

8. The polymeric blocker of claim 1, wherein the first and second adhesives are independently selected from the group consisting of: polyethylene resin, polypropylene resin, polybutylene resin, urethane resin, polyamide resin, ethylene, propylene, butene, silicon, polyimide resin, epoxy resin, acrylic resin, ethylene-propylenediene rubber (EPDM), isocyanate adhesive, acrylic resin adhesive, cyanoacrylate adhesive, and combinations thereof.

9. An electrochemical cell that cycles lithium ions, the electrochemical cell comprising:
a first current collector;
a second current collector parallel with the first current collector;
a first polymer blocker connecting a first side of the first current collector to a first side of the second current collector; and
a second polymer blocker connecting a second side of the first current collector and a second side of the second current collector to form a sealed area defined by the first current collector, the second current collector, the first polymer blocker, and the second polymer blocker, the first and second polymer blockers comprising:
a polymeric layer having a porosity greater than or equal to about 50 vol. % to less than or equal to about 95 vol. %
a first adhesive layer comprising a first adhesive and disposed on or near a first surface of the polymeric layer, a portion of the first adhesive impregnating a first portion of the polymeric layer; and
a second adhesive layer comprising a second adhesive and disposed on or near a second surface of the polymeric layer, the second surface of the polymeric layer being parallel with the first surface of the polymeric layer, a portion of the second adhesive impregnating a second portion of the polymeric layer, the first and second portions of the polymeric layer may be the same or different.

10. The electrochemical cell of claim 9, wherein the sealed area comprises:
a positive electroactive material layer;
a negative electroactive material layer; and
an electrolyte layer disposed between and physically separating the positive electroactive material layer and the negative electroactive material layer.

11. The electrochemical cell of claim 10, wherein the electrolyte layer comprises a polymeric gel electrolyte.

12. The electrochemical cell of claim 10, wherein at least one of the positive electroactive material layer and the negative electroactive material layer comprises a polymeric gel electrolyte.

13. The electrochemical cell of claim 10, wherein the first and second adhesive together fill greater than or equal to about 80% to less than or equal to about 100% of a total porosity of the polymeric layer.

14. The electrochemical cell of claim 10, wherein the polymeric layer comprises a material selected from the group consisting of: polyester nonwoven separator, cellulose separator, polyvinylidene fluoride (PVDF) membrane, polyimide membrane, polyolefin-based separator, ceramic-coating separator, high-temperature stable separator, oxide particle layers, and combinations thereof.

15. The electrochemical cell of claim 10, wherein at least one of the first and second adhesives comprises a hot-melt adhesive.

16. The electrochemical cell of claim 10, wherein at least one of the first and second adhesives comprises an amorphous polypropylene resin prepared by copolymerizing at least two of ethylene, propylene, and butene.

17. The electrochemical cell of claim 10, wherein the first and second adhesives are independently selected from the group consisting of: polyethylene resin, polypropylene resin, polybutylene resin, urethane resin, polyamide resin, ethylene, propylene, butene, silicon, polyimide resin, epoxy resin, acrylic resin, ethylene-propylenediene rubber (EPDM), isocyanate adhesive, acrylic resin adhesive, cyanoacrylate adhesive, and combinations thereof.

18. A method for forming a polymer blocker for use in an electrochemical battery that cycles lithium ions, the method comprising:
hot pressing a precursor polymer blocker, the hot pressing comprising applying a pressure greater than or equal to about 10 MPa to less than or equal to about 300 MPa at a temperature greater than or equal to about 100° C. to less than or equal to about 300° C., the precursor polymer blocker comprising:
a polymeric layer having a porosity greater than or equal to about 50 vol. % to less than or equal to about 95 vol. %
a first precursor adhesive layer comprising a first adhesive and disposed on or near a first surface of the polymeric layer, wherein after hot pressing, wherein after hot pressing, the first precursor adhesive layer forms a first adhesive layer comprising a portion of the first adhesive that impregnates a first portion of the polymeric layer; and
a second precursor adhesive layer comprising a second adhesive and disposed on or near a second surface of the polymeric layer, the second surface of the polymeric layer being parallel with the first surface of the polymeric layer, wherein after hot pressing, the second precursor adhesive layer forms a second adhesive layer comprising a portion of the second adhesive that impregnates a second portion of the polymeric layer, and the first and second portions of the polymeric layer being the same or different.

19. The method of claim 18, wherein the first and second precursor adhesive layers have average thicknesses greater than or equal to about 500 μm to less than or equal to about 700 μm, and
the first and second adhesive layers have average thicknesses greater than or equal to about 5 μm to less than or equal to about 200 μm.

20. The method of claim 18, wherein the first and second adhesives together fill greater than or equal to about 80% to less than or equal to about 100% of a total porosity of the polymeric layer.
